(19) United States
(12) Patent Application Publication
(10) Pub. No.: US 2011/0238271 A1
(43) Pub. Date: Sep. 29, 2011

(54) SHIFT METHOD FOR A DUAL-CLUTCH TRANSMISSION FOR VEHICLES

(75) Inventor: Goetz HANGEN, Wolfsheim (DE)

(73) Assignee: GM GLOBAL TECHNOLOGY OPERATIONS LLC, Detroit, MI (US)

(21) Appl. No.: 13/044,211

(22) Filed: Mar. 9, 2011

(30) Foreign Application Priority Data
Mar. 12, 2010 (DE) 102010011241.0

(51) Int. Cl. F16H 61/00

(52) U.S. Cl. 701/51; 192/3.51

(57) ABSTRACT

A shift method is provided for a vehicle transmission. In the vehicle transmission, forward gears are operated using at least one engine clutch via at least one transmission drive shaft. A downshift from one of the forward gears to another of the forward gears, which are assigned to the at least one engine clutch or the at least one transmission drive shaft, is performed in that synchronizing clutches of the intermediate gears, which are between one of the forward gears and the other of the forward gears on the same transmission drive shaft, are successively operated.

### CROSS-REFERENCE TO RELATED APPLICATION

This application claims priority to German Patent Application No. 102010011241.0, filed Mar. 12, 2010, which is incorporated herein by reference in its entirety.

### TECHNICAL FIELD

The technical field relates to a shift method for a vehicle transmission, a computer program and a computer program product for performing the shift method. In the vehicle transmission, forward gears are operated using at least one engine clutch via at least one transmission drive shaft.

### BACKGROUND

A transmission can be used as an automatic shift transmission or as a manually-operated shift transmission. Rotationally-fixed drive gearwheels of the forward gears and one reverse gear, which mesh with output gearwheels of the gears mounted so they are rotatable on a transmission output shaft, are typically fixed on the transmission drive shaft. Dual-sided acting rotationally-fixed and axially-displaceable synchronizing clutches are typically situated between the output gearwheels on the output shaft. When a gear is engaged, one of the synchronizing clutches is engaged with one of the output gearwheels via an axially-displaceable shift sleeve.

When upshifting the gears, a synchronizing clutch, with the aid of synchronizing rings after release of the output gearwheel of the prior low gear, depending on the selection of the selected higher gear, brakes the rotatably mounted output gearwheel of the selected higher gear and additionally the meshing drive gearwheel of the selected higher gear and the transmission drive shaft thus fixed having all drive gearwheels fixed on the transmission drive shaft, until a synchronous speed of the selected output gearwheel with the speed of the transmission output shaft is reached, and the shift sleeve can be axially displaced using a selector fork to the selected output gearwheel. The further apart the current gear and the selected gear lie when upshifting, the greater the braking power to be applied by the synchronizing clutch of the higher gear. The synchronizing clutch is accordingly to be designed as large enough to reliably synchronize the highest possible gear difference.

When downshifting the gears, one of the synchronizing clutches, with the aid of synchronizing rings after release of the output gearwheel of the prior high gear, depending on the selection of the selected low gear, accelerates the rotatably mounted output gear-wheel of the selected lower gear and the meshing drive gearwheel of the selected lower gear and the transmission drive shaft thus fixed, with all drive gearwheels fixed on the transmission drive shaft, until a synchronous speed of the selected output gearwheel with the speed of the transmission output shaft is reached and the shift sleeve can be axially displaced using a selector fork to the selected output gearwheel. The further apart the current gear and the selected gear lie when downshifting, the greater the acceleration power to be transferred by the synchronizing clutch of the lower gear. The synchronizing clutch is accordingly to be designed as large enough to reliably synchronize the highest possible gear difference.

Correspondingly, the material of such a synchronizing clutch must be dimensioned thicker than if only small gear differences are to be synchronized, so that for an upshift from a first gear to a sixth gear, for example, or a downshift from a sixth gear to a first gear, for example, of a six-gear vehicle transmission having six forward gears, relatively large-volume and heavy synchronizing clutches are to be provided, which require both a high weight and also a high required space of such vehicle transmissions. In order to automatically control and monitor such vehicle transmissions, transmission control units and engine control units are provided in modern vehicles, which monitor the speed of the transmission drive shafts, the transmission output shaft, and the engine shaft via tachometers.

FIG. 3 shows a vehicle transmission having two transmission drive shafts, which cooperate with a dual clutch. Such dual-clutch transmissions have a dual clutch 4, in which a first engine clutch 6 and a second engine clutch 7 are situated. The first engine clutch 6 can be coupled to a first transmission drive shaft 8. Drive gearwheels 31, 32, and 33 of odd-numbered forward gears V1, V3, and V5 are situated on the first transmission drive shaft 8. The second engine clutch 7 can be coupled to a second transmission drive shaft 9. Drive gearwheels 34, 35, and 36 of even-numbered forward gears V2, V4, and V6 are situated on the transmission drive shaft 9.

When downshifting over multiple gears, for example, from V6 to V2, the drive gearwheel 34 meshing with the output gearwheel 44 must be accelerated to high speeds with the aid of the synchronizing clutch 13. The greater the gear difference at which a synchronizing clutch 13 has to shift, in order to perform an acceleration of the speed of the transmission drive shaft with the aid of the synchronizing ring 13, the output gearwheel 44, and the drive gearwheel 34 meshing therewith, the thicker must the material of such a synchronizing clutch be dimensioned, so that a downshift from a sixth gear V6 to a second gear V2 requires a relatively large-volume synchronizing clutch 13 for the second gear V2, so that it accelerates the high acceleration forces to accelerate the corresponding output gearwheel 44 of the second gear V2 and the drive gearwheel 34 meshing with this output gearwheel 44, as well as the corresponding drive shaft 9 having its drive gearwheels 30, 34, 35, 36 and the freewheeling output gearwheels 40, 44, 45, and 46.

For a smooth increase of the actual speed of the corresponding transmission drive shaft 9, firstly a changeover is performed to the freewheeling first drive shaft 8 and to a fifth gear. However, the speed difference still remains between the fifth gear and the second gear, so that the synchronizing clutch 13 of the second gear V2 must allow a correspondingly high force transmission and is accordingly to be designed as voluminous. The automatic shift procedures are monitored and controlled by a transmission control unit 15 with the aid of tachometers 22 to 25.

This is also illustrated by the graph shown in FIG. 4. In FIG. 4, a shift is to be performed from a current speed nV6 of a sixth gear of approximately 1930 rpm, which is plotted on the ordinate of the graph, to a high speed nV2 of a second gear at approximately 6200 rpm. The speed nV4 of the fourth gear does lay in between, however, in the prior shift methods for a dual-clutch transmission, it was assumed that after brief intermediate shifting of an odd gear such as the fifth gear, the synchronizing clutch of the second gear accepts the full load to reach the high speed nV2.

While the speed of the drive shaft is shown as the actual speed nMot from the shift moment t1, at which a downshift is requested, until reaching the high speed nV2 with intermediate shifting of the fifth gear, for example, in FIG. 4 using a solid line, the delayed engagement of the second synchronizing clutch and its speed curve is marked by a dashed line. The delay occurs in that first a shift is to be formed into a next lower odd-numbered gear of the first output shaft, in order to ensure a smooth curve of the actual speed, as shown in FIG. 3. However, in order to apply the acceleration forces with the aid of the synchronizing clutch, a corresponding voluminously dimensioned synchronizing clutch is required for the second gear.

In view of the foregoing, at least one object is to reduce the weight of a vehicle transmission and nonetheless to ensure reliable downshifting and upshifting over multiple gear steps for a dual-clutch transmission. In addition, it is at least another object to save fuel using a reduced transmission weight. Furthermore, other objects, desirable features and characteristics will become apparent from the subsequent summary and detailed description, and the appended claims, taken in conjunction with the accompanying drawings and this background.

### SUMMARY

A vehicle transmission is provided having an engine clutch and a new shift method is also provided for the vehicle transmission. In the vehicle transmission, forward gears are operated using at least one engine clutch via at least one transmission drive shaft. A down-shift from one of the forward gears to another of the forward gears, which are assigned to the at least one engine clutch and/or the at least one transmission drive shaft, is performed in that successive synchronizing clutches of those intermediate gears that are operated between one of the forward gears and the other of the forward gears on the same transmission drive shaft are successively activated.

This shift method has the advantage that the energy introduction and therefore the load when downshifting is allocated to at least two synchronizing clutches, and the resulting design of the synchronizing clutches can therefore be significantly smaller. The advantage is connected to smaller synchronizing clutches that the total weight of the dual-clutch transmission can be reduced, without endangering the reliability of the downshifting over multiple forward gears or overloading the weaker synchronizing clutches. In order to increase the reliability so that the synchronizing clutches of the intermediate gears are successively used until the required speed synchronization is reached, a transmission control unit is programmed appropriately so that overload of the synchronizing clutches which are designed as weaker cannot occur. This is also true for upshifting of gears.

Another embodiment relates to a vehicle transmission having a dual clutch, which has two engine clutches. Odd-numbered forward gears are operated using a first engine clutch of the dual clutch via a first transmission drive shaft. Even-numbered forward gears are operated using a second engine clutch via a second transmission drive shaft. A down-shift from one of the forward gears to another of the forward gears, which are assigned to one of the transmission drive shafts, is performed in that successive synchronizing clutches of those intermediate gears which are operated between one of the forward gears and the other of the forward gears on the same transmission drive shaft are successively activated.

This shift method has the advantage that the energy introduction and the synchronization power can be allocated to multiple synchronizing clutches, so that weaker or smaller synchronizing clutches can be used in the dual-clutch transmission. The advantage is connected to smaller synchronizing clutches that the total weight of the dual-clutch transmission can be reduced, without endangering the reliability of the downshifting over multiple forward gears or overloading the weaker synchronizing clutches. This is also true for upshifting of gears.

In a preferred embodiment, the speed of the associated transmission drive shaft is increased step-by-step by coupling on the synchronizing clutches of the intermediate gears step-by-step during downshifting over multiple forward gears. Thus, the forward gears V1, V3, and V5 are operated using the first engine clutch of a six-gear dual-clutch transmission, and the third forward gear V3 is activated as an intermediate gear when downshifting from the fifth forward gear V5 in the first forward gear V1.

It is similar when downshifting into the even-numbered gears, the forward gears V2, V4, and V6 being operated using the second engine clutch of a six-gear dual-clutch transmission and the fourth forward gear V4 being activated as the intermediate gear when downshifting from the sixth forward gear V6 into the second forward gear V2. Of course, to ensure smooth shifting of the dual-clutch transmission, a brief changeover must be made in each case between these even-numbered gears, for example, to the first transmission shaft having the corresponding odd-numbered gears.

In a further embodiment, when downshifting, the engine drive is used to accelerate the transmission drive shaft to be synchronized, so that only a slight differential speed remains for the synchronizing clutches. However, for this purpose, the engine clutch which is currently engaged must be reduced in its torque transfer, in order to accelerate the engine to increase the speed of the non-engaged transmission drive shaft of a dual-clutch transmission.

For this purpose, firstly the assigned synchronizing clutch of the high forward gear in operation is disengaged. The associated engine clutch is then activated and the transmission drive shaft is accelerated to a higher speed. Before reaching the increased speed of the transmission drive shaft for the forward gear to be engaged, which is multiple gears lower, the engine clutch is deactivated and the associated synchronizing clutch of the lower forward gear to be reached is activated, which now must only compensate for a reduced speed difference.

Thus, the forward gears V1, V3, and V5 can be operated using the first engine clutch of a six-gear dual-clutch transmission and when downshifting from the fifth forward gear V5 into the first forward gear V1, with freewheeling synchronizing clutches, the speed of the first transmission drive shaft can be accelerated with the aid of the engine and, before reaching the increased speed of the first transmission drive shaft for the first forward gear V1 to be engaged, the associated engine clutch can be deactivated and the associated synchronizing clutch of the first forward gear V1 can be activated. In the acceleration phase of the first transmission drive shaft, the torque is adopted by one of the gears of the second output shaft, in order to ensure smooth shifting of the dual-clutch transmission. The upshifting can also be performed similarly.

A similar action is possible using the second engine clutch of the dual-clutch transmission, using which the forward gears V2, V4, and V6 are operated. When down-shifting from the sixth forward gear into the second forward gear, the second engine clutch is activated with freewheeling synchronizing clutches and the speed of the second transmission drive shaft is accelerated with the aid of the engine. Before reaching the increased speed of the second transmission drive shaft for the second forward gear to be engaged, the associated engine clutch is deactivated and the associated synchronizing clutch of the second forward gear is activated and engaged. For smooth changeover and operation of the output shaft, the torque is at least temporarily adopted by the respective other transmission output shaft. The upshifting can also be performed similarly.

A further embodiment relates to a computer program which is programmed to apply the method according to one of the above exemplary embodiments. The computer program product is implemented to perform all steps of one of the described methods when the computer program is executed on a computer unit or a corresponding control unit.

### BRIEF DESCRIPTION OF THE DRAWINGS

The present invention will hereinafter be described in conjunction with the following drawing figures, wherein like numerals denote like elements, and:

FIG. 1 shows a graph of speed curves of a transmission drive shaft (bold, dashed) of the engine speed nMot and the associated synchronous speeds of the corresponding forward gears (nV2, nV4, nV6) according to an embodiment of the invention;

FIG. 2 shows a graph of speed curves of the engine speed (nMot) and a transmission drive shaft (bold, dashed), which show the engagement ranges of the subsections designated by nMK and the subsection designated by nS2 of the synchronizing clutch when downshifting from multiple forward gears according to a further embodiment of the invention;

FIG. 3 shows a schematic sketch of a dual-clutch transmission for the use of a method according to an embodiment of the invention; and

FIG. 4 shows a graph of speed curves of a transmission input shaft and a synchronizing clutch when downshifting by multiple forward gears of a dual-clutch transmission according to the prior art.

### DETAILED DESCRIPTION

The following detailed description is merely exemplary in nature and is not intended to limit application and uses. Furthermore, there is no intention to be bound by any theory presented in the preceding background or summary or the following detailed description.

FIG. 1 shows a graph of speed curves of an engine speed nMOT and the transmission drive shaft (bold, dashed), the speed being shown in rpm [U/min] on the ordinate. This engine speed nMOT corresponds at time t1 to the speed of the sixth forward gear, which is approximately 1900 rpm. The bold dashed transmission input speed is increased step-by-step according to the invention by a first synchronizing clutch for the fourth gear and a second synchronizing clutch for the second gear to the speed nV2 of the second gear at 6200 rpm. Since, as shown by the dashed line, first the transfer velocity nS4 of the synchronizing clutch of the fourth gear and subsequently the speed nS2 of the synchronizing clutch of the second gear are successively applied, the acceleration forces to increase or accelerate the actual velocity for each synchronizing clutch are reduced, so that smaller synchronizing clutches may be used.

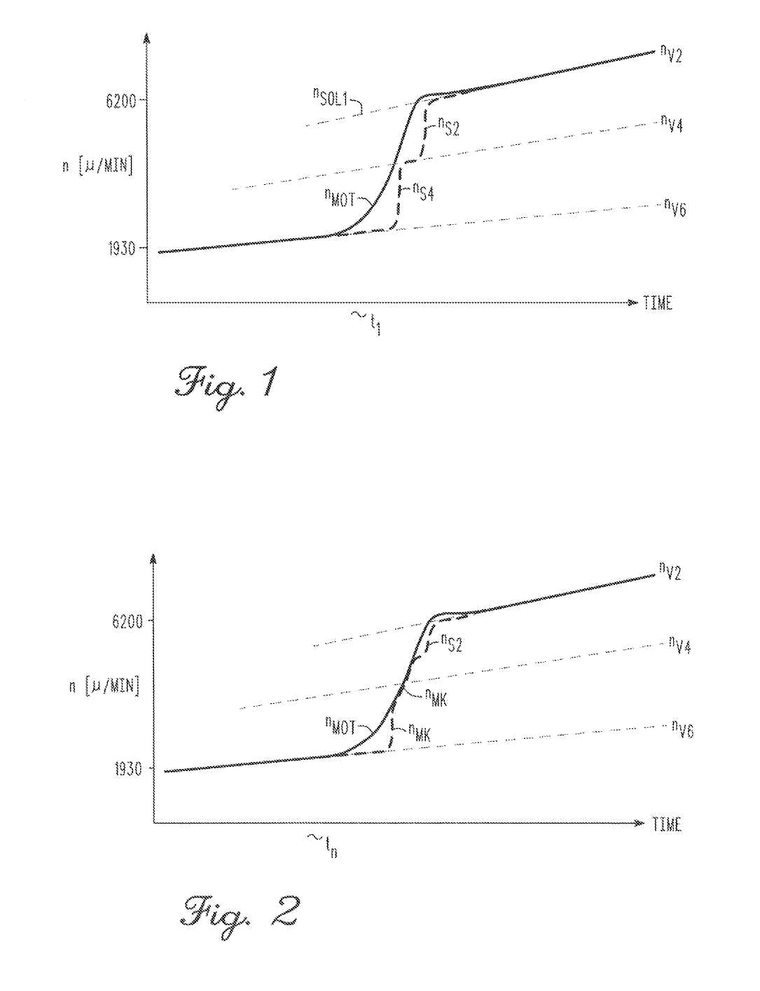

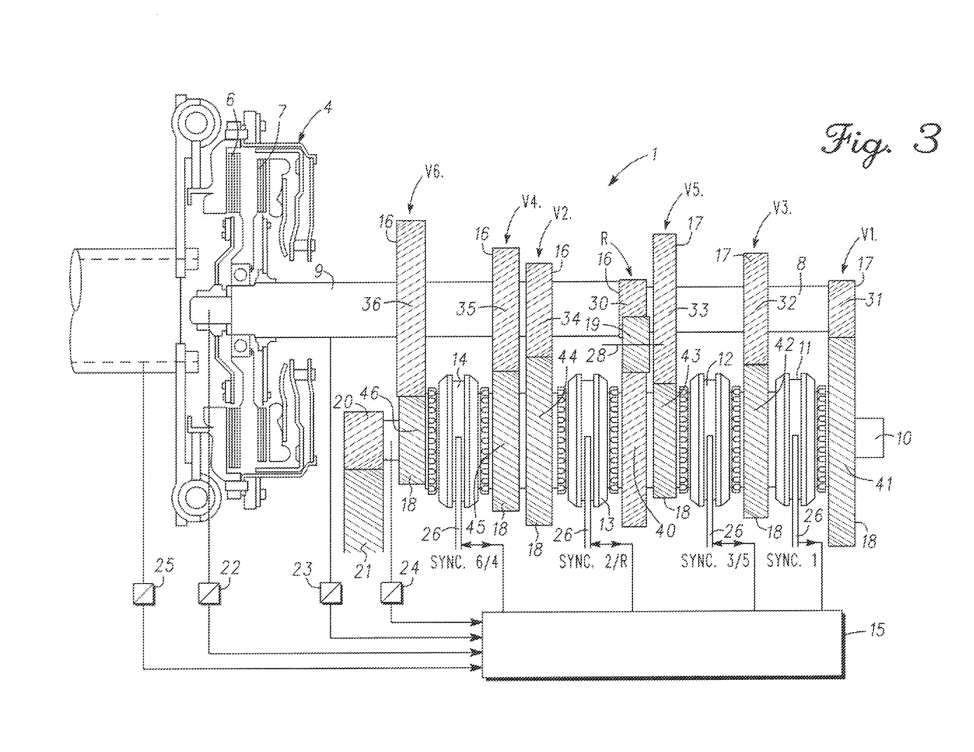

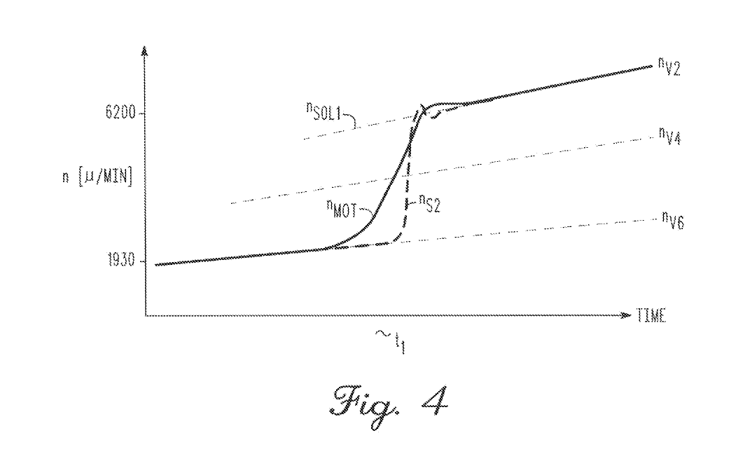

FIG. 2 shows a graph of speed curves of the engine speed nMot and a transmission drive shaft (bold, dashed) and an engine clutch as well as a synchronizing clutch when downshifting multiple forward gears according to a further exemplary performance of the invention. The difference from the first example is that one of the engine clutches is used here, from the speed nV6 of the sixth gear, to accelerate the speed with the aid of an engine clutch and therefore with the aid of the engine beyond the speed nV4 of the fourth gear, before the synchronizing clutch of the second gear and therefore the speed nS2 is used to reach the final speed nV2 of the second gear. The synchronizing clutch of the second gear can also be designed as weaker for this purpose, since the acceleration forces are applied by the engine clutch and/or by the engine in a supporting manner.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A shift method for a vehicle transmission, comprising:
operating a plurality of forward gears using a clutch via a transmission drive shaft;
performing a downshift from a first forward gear of the plurality of forward gears to a second forward gear of the plurality of forward gears; and
operating a plurality of synchronizing clutches of a plurality of intermediate gears that are between the first forward gear and the second forward gear on the transmission drive shaft.

2. The shift method according to claim 1, a speed of the transmission drive shaft is increased step-by-step by coupling the plurality of synchronizing clutches step-by-step onto an output shaft via a plurality of output gearwheels of the plurality of intermediate gears when downshifting.

3. The shift method according to claim 2, wherein using a first engine clutch of a six-gear dual-clutch transmission, the first forward gear, a third forward gear, and a fifth forward gear are operated, and when downshifting from the fifth forward gear into the first forward gear, the third forward gear is activated as an intermediate gear.

4. A shift method for a vehicle transmission, comprising:
operating a plurality of forward gears using an engine clutch via a transmission drive shaft;
performing a downshift from a first forward gear of the plurality of forward gears to a second forward gear of the plurality of forward gears;
releasing a high forward gear;
disengaging a synchronizing clutch;
reactivating the engine clutch;
accelerating the transmission drive shaft with an engine to a higher speed; and
deactivating the engine clutch and activating the synchronizing clutch of a lower forward gear before reaching an increased speed of the transmission drive shaft.

5. The shift method according to claim 4, further comprising:
operating odd-numbered forward gears using a first engine clutch of a dual clutch via a first transmission drive shaft;
operating even-numbered forward gears using a second engine clutch of the dual clutch via a second transmission drive shaft; and performing a downshift from one of the forward gears to another of the forward gears that are assigned to one of the transmission drive shafts; and
successive activating synchronizing clutches of those intermediate gears that are operated between one of the forward gears and the other of the forward gears on the transmission drive shaft.

6. The shift method according to claim 5, wherein using the first engine clutch of a six-gear dual-clutch transmission, the first forward gear, a third forward gear, and a fifth forward gear are operated, and when downshifting from the fifth forward gear into the first forward gear, the third forward gear is activated as an intermediate gear.

7. The shift method according to claim 5, wherein using the second engine clutch of a six-gear dual-clutch transmission, the second forward gear, a fourth forward gear, and a sixth forward gear, and are operated, and when downshifting from the sixth forward gear into the second forward gear, the fourth forward gear is activated as an intermediate gear.

8. A shift method according to claim 5, wherein odd-numbered forward gears are operated using the first engine clutch of the dual clutch via the first transmission drive shaft, wherein even-numbered forward gears are operated using the second engine clutch of the dual clutch via the second transmission drive shaft, and
wherein a downshift from one of the forward gears to another of the forward gears, which are assigned to one of the transmission drive shafts, is performed in that,
firstly an assigned engine clutch releases the high forward gear in operation and disengages an associated synchronizing clutch, the assigned engine clutch is then reactivated and the transmission drive shaft is accelerated to a higher speed and, before reaching the increased speed of the transmission drive shaft for the other forward gear to be engaged, an associated engine clutch is deactivated and the associated synchronizing clutch of a low forward gear to be reached is activated.

9. The shift method according to claim 8, wherein using the first engine clutch of a six-gear dual-clutch transmission, the first forward gear, a third forward gear, and a fifth forward gear are operated, and when downshifting from the fifth forward gear into the first forward gear, the first engine clutch, with freewheeling synchronizing clutches, accelerates a speed of the first transmission drive shaft with the aid of the engine and, before reaching the increased speed of the transmission drive shaft for the first forward gear to be engaged, an associated first engine clutch is deactivated and the associated synchronizing clutch of the first forward gear is activated.

10. The shift method according to claim 8, wherein using the second engine clutch of a dual clutch transmission, the second forward gear, a fourth forward gear, and a sixth forward gear are operated, and when downshifting from the sixth forward gear into the second forward gear, the second engine clutch, with freewheeling synchronizing clutches, accelerates a speed of the second transmission drive shaft with the aid of the engine and, before reaching the increased speed of the transmission drive shaft for the second forward gear to be engaged, the associated engine clutch is deactivated and the associated synchronizing clutch of the second forward gear is activated.

11. A computer readable medium embodying a computer program product, said computer program product comprising:
a shift program for a vehicle transmission, the shift program configured to:
operate a plurality of forward gears using a clutch via a transmission drive shaft;
perform a downshift from a first forward gear of the plurality of forward gears to a second forward gear of the plurality of forward gears; and
operate a plurality of synchronizing clutches of a plurality of intermediate gears that are between the first forward gear and the second forward gear on the transmission drive shaft.

12. The computer readable medium according to claim 11, the shift program is further configured to increase a speed of the transmission drive shaft step-by-step by coupling the plurality of synchronizing clutches step-by-step onto an output shaft via a plurality of output gearwheels of the plurality of intermediate gears when downshifting.

13. The computer readable medium according to claim 12, wherein the shift program is further configured to use a first engine clutch of a six-gear dual-clutch transmission, the first forward gear, a third forward gear, and a fifth forward gear are operated, and when downshifting from the fifth forward gear into the first forward gear, the third forward gear is activated as an intermediate gear.

14. A computer readable medium embodying a computer program product, said computer program product comprising:
a shift program, the shift program configured to:
operate a plurality of forward gears using an engine clutch via a transmission drive shaft;
perform a downshift from a first forward gear of the plurality of forward gears to a second forward gear of the plurality of forward gears;
release a high forward gear;
disengage a synchronizing clutch;
reactivate the engine clutch;
accelerate the transmission drive shaft with an engine to a higher speed; and
deactivate the engine clutch and activating the synchronizing clutch of a lower forward gear before reaching an increased speed of the transmission drive shaft.

15. The computer readable medium according to claim 14, the shift program further configured to:
operate odd-numbered forward gears using a first engine clutch of a dual clutch via a first transmission drive shaft;
operate even-numbered forward gears using a second engine clutch of the dual clutch via a second transmission drive shaft; and perform a downshift from one of the forward gears to another of the forward gears that are assigned to one of the transmission drive shafts; and
successively activate synchronizing clutches of those intermediate gears that are operated between one of the forward gears and the other of the forward gears on the transmission drive shaft.

16. The computer readable medium according to claim 15, the shift program is further configured to use the first engine clutch of a six-gear dual-clutch transmission, the first forward gear, a third forward gear, and a fifth forward gear are operated, and when downshifting from the fifth forward gear into the first forward gear, the third forward gear is activated as an intermediate gear.

17. The computer readable medium according to claim 15, the shift program is further configured to use the second engine clutch of a six-gear dual-clutch transmission, the second forward gear, a fourth forward gear, and a sixth forward gear, and are operated, and when downshifting from the sixth forward gear into the second forward gear, the fourth forward gear is activated as an intermediate gear.

18. A computer readable medium according to claim 15, wherein the shift program is further configured to:
operate odd-numbered forward gears using the first engine clutch of the dual clutch via a first transmission drive shaft, operate even-numbered forward gears using the second engine clutch of the dual clutch via the second transmission drive shaft;
perform a downshift from one of the forward gears to another of the forward gears, which are assigned to one of the transmission drive shafts;
firstly operate an assigned engine clutch to release the high forward gear in operation and disengage an associated synchronizing clutch, and subsequently reactivate the assigned engine clutch and accelerate the transmission drive shaft to a higher speed and, before reaching the increased speed of the transmission drive shaft for the other forward gear to be engaged, deactivate an associated engine clutch and activate the associated synchronizing clutch of a low forward gear to be reached.

19. The computer readable medium according to claim 18, wherein the shift program is further configured to operate the first engine clutch of a six-gear dual-clutch transmission, the first forward gear, a third forward gear, and a fifth forward gear, and when downshifting from the fifth forward gear into the first forward gear, the first engine clutch, with freewheeling synchronizing clutches, accelerate the speed of the first transmission drive shaft with the aid of the engine and, before reaching the increased speed of the transmission drive shaft for the first forward gear to be engaged, deactivate an associated first engine clutch and activate the associated synchronizing clutch of the first forward gear.

20. The computer readable medium according to claim 18, wherein the shift program is further configured to operate the second engine clutch of a dual clutch transmission, the second forward gear, a fourth forward gear, and a sixth forward gear, and when downshifting from the sixth forward gear into the second forward gear, the second engine clutch, with freewheeling synchronizing clutches, accelerate the speed of the second transmission drive shaft with the aid of the engine and, before reaching the increased speed of the transmission drive shaft for the second forward gear to be engaged, deactivate the associated engine clutch and activate the associated synchronizing clutch of the second forward gear.
